(19) United States
(12) Patent Application Publication
(10) Pub. No.: US 2025/0045356 A1
(43) Pub. Date: Feb. 6, 2025

(54) INFORMATION PROCESSING APPARATUS, INFORMATION PROCESSING METHOD, AND NON-TRANSITORY COMPUTER READABLE MEDIUM

(71) Applicant: Rakuten Group, Inc., Tokyo (JP)

(72) Inventors: Shion Ishikawa, Tokyo (JP); Yun Ching Liu, Tokyo (JP)

(73) Assignee: Rakuten Group, Inc., Tokyo (JP)

(21) Appl. No.: 18/789,122

(22) Filed: Jul. 30, 2024

(30) Foreign Application Priority Data
Jul. 31, 2023 (JP) 2023-124134

(51) Int. Cl. G06F 17/18; G06F 17/16

(52) U.S. Cl. CPC G06F 17/18; G06F 17/16

(57) ABSTRACT

An information processing apparatus acquires a placement probability that expresses a probability of each of n items, where n is a natural number of 2 or higher, being placed at k positions, where k is a natural number of 2 or higher, converts the n items into m embedding vectors, where m is a natural number of 2 or higher, that express abstract representations of features of the n items, calculates an assignment probability that expresses a probability of assignment from the n items to the m embedding vectors, and derives, using a distribution of the placement probability and a distribution of the assignment probability, a probability expression of each of the m embedding vectors being placed at each of the k positions.

### CROSS-REFERENCE TO RELATED APPLICATION(S)

This application claims priority to Japanese patent application No. 2023-124134, filed on Jul. 31, 2023; the entire contents of which are incorporated herein by reference.

### TECHNICAL FIELD

The present invention relates to an information processing apparatus, an information processing method, and a program thereof.

### BACKGROUND ART

In recent years, rankings of various items, such as products and search results, have been widely provided on web services used by users. Click data, such as click histories of users, are used to construct such rankings.

Click data can be referred to as “implicit feedback” because it is generated by actions taken by users, not by explicit statements or ratings provided by users. That is, click data can reflect how users actually behave when interacting with a system or website, and not what users like or dislike. Since it provides rich feedback in an implicit manner, click data is used to improve personalized rankings

When a user selects and clicks on an item that is freely chosen out of a plurality of items displayed on a screen, since the user visually confirms the items before clicking on one, the positions of items can affect this process of the user visually confirming items and clicking on them. Bias due to items' positions that affects how a user views items is called “position bias”. NPL 1 shown below discloses a technology that estimates position bias according to a regression-type expectation-maximization (EM) algorithm, based on the positions at which items are placed and a click history of the items.

Xuanhui Wang, et al., “Position Bias Estimation for Unbiased Learning to Rank in Personal Search”, Proceedings of the 11th ACM International Conference on Web Search and Data Mining (WSDM), ACM (2018), pp. 610-618 (NPL 1) is an example of related art.

### SUMMARY OF THE INVENTION

On a screen that displays a plurality of items, individual items in the plurality of items are often placed at fixed positions. As one example, in a carousel advertisement, the placement and order of the respective items are determined in advance by the creator of the advertisement. In this way, in situations where a plurality of items are placed at fixed positions, there will be bias in the positions at which the items are placed. In other words, there will be bias in the positions at which items are actually placed relative to the plurality of potential positions at which the items could be placed.

The document cited above does not disclose a mechanism for estimating position bias that takes into account the influence of bias in placement positions for when bias occurs in the placement positions of items.

In view of the problems described above, it is an object of the present disclosure to establish an algorithm for estimating position bias by taking into account the influence of bias in the placement positions of items, even when such bias occurs.

An information processing apparatus according to an aspect of the present disclosure includes: an acquisition unit that acquires a placement probability that expresses a probability of each of n items, where n is a natural number of 2 or higher, being placed at k positions, where k is a natural number of 2 or higher; a conversion unit that converts the n items into m embedding vectors, where m is a natural number of 2 or higher, that express abstract representations of features of the n items; a calculation unit that calculates an assignment probability that expresses a probability of assignment from the n items to the m embedding vectors; and a deriving unit that derives, using a distribution of the placement probability and a distribution of the assignment probability, a probability expression of each of the m embedding vectors being placed at each of the k positions.

An information processing method according to an aspect of the present disclosure includes: acquiring a placement probability that expresses a probability of each of n items, where m is a natural number of 2 or higher, being placed at k positions, where k is a natural number of 2 or higher; converting the n items into m embedding vectors, where m is a natural number of 2 or higher that express abstract representations of features of the n items; calculating an assignment probability that expresses a probability of assignment from the n items to the m embedding vectors; and deriving, using a distribution of the placement probability and a distribution of the assignment probability, a probability expression of each of the m embedding vectors being placed at each of the k positions.

A program according to an aspect of the present disclosure is a program for causing a computer to execute an information processing method, the information processing method includes: acquiring a placement probability that expresses a probability of each of n items, where n is a natural number of 2 or higher, being placed at k positions, where k is a natural number of 2 or higher; converting the n items into m embedding vectors, where m is a natural number of 2 or higher, that express abstract representations of features of the n items; calculating an assignment probability that expresses a probability of assignment from the n items to the m embedding vectors; and deriving, using a distribution of the placement probability and a distribution of the assignment probability, a probability expression of each of the m embedding vectors being placed at each of the k positions.

According to the present invention, there is provided an algorithm for estimating position bias that takes into account the influence of bias in the placement positions of items.

### BRIEF DESCRIPTION OF THE DRAWINGS

FIG. 1 depicts an example configuration of an information processing system.

FIG. 2A depicts an example distribution of a placement probability π(i,k) according to an embodiment.

FIG. 2B depicts an example distribution of an assignment probability P(e|i) according to the embodiment.

FIG. 2C depicts an example distribution of a placement probability π(e,k) according to the embodiment.

FIG. 3 is a diagram useful in explaining generation of embedding vectors.

FIG. 4 depicts an algorithm according to the embodiment.

FIG. 5 depicts an example functional configuration of an information processing apparatus.

FIG. 6 is an example content in which a plurality of items have been placed at a plurality of positions.

FIG. 7 depicts an example hardware configuration of an information processing apparatus according to the embodiment.

### EMBODIMENTS OF THE INVENTION

Embodiments of the present invention will now be described in detail with reference to the accompanying drawings. Out of the component elements described below, elements with the same functions have been assigned the same reference numerals, and description thereof is omitted. Note that the embodiments disclosed below are mere example implementations of the present invention, and it is possible to make changes and modifications as appropriate according to the configuration and/or various conditions of the apparatus to which the present invention is to be applied. Accordingly, the present invention is not limited to the embodiments described below. The combination of features described in these embodiments may include features that are not essential when implementing the present invention.

The present embodiment uses a probabilistic model that is an improvement on a position-based click model, which is disclosed in NPL 1 and expresses a probabilistic model of the probability that a user will click on an item. First, the conventional position-based click model disclosed in the cited document will be described, and then a configuration for estimating position bias according to a regression-type EM algorithm based on a model that is an improvement on this conventional position-based click model will be described. Note that in the present disclosure, the term “probability” should be understood as the ratio at which a target event occurs, rather than referring to a possibility that is unknown.

### Conventional Position-Based Click Model

The position-based click model disclosed in NPL 1 will now be described. Here, it is assumed that the user clicks on a freely chosen item out of one or a plurality of recommended items (for example, advertisements or products) that have been displayed (placed) on a display screen in relation to a web service.

Assume that the item i is a recommended item. Assume that the variable C is a reward variable. If a click is the subject to a reward, when the variable Cis “1”, this indicates that a displayed item was clicked, and when the variable C is “0”, this indicates that a displayed item was not clicked. Assume that the user u is a user with a user context including one or more user attributes (information relating to a user device or the user himself/herself) that are specific to the user u. Assume that the position k is the position at which an item is displayed out of a plurality of potential display (or “placement candidate”) positions.

In a location-based click model, the click probability P(C=1|i,u,k) that has the item i, the user u, and the position k as conditions is expressed as the product of two latent probabilities as expressed in Equation (1).

$$P ( C = 1 \vert i , u , k ) = P ( R = 1 \vert i , u ) P ( E = 1 \vert k ) \qquad ( 1 )$$

Here, P(E=1|k) represents the probability that the position k is visually recognized (or “examined”) by the user. Such “examination” may include the user recognizing the position k unconsciously or without being explicitly aware of doing so. P(R=1|i, u) represents the probability that there is relevance between the item i and the user u. Here, the expression “relevance” means that the user context of the user u is related to the item features of an item. As one example, if the user context of the user u includes the user attribute “owns a car”, items that are automobile-related goods can be assumed to be relevant to the user u.

In this way, the position-based click model expressed in Equation (1) is based on the assumption that if a user examines a given position and the item placed at that position is relevant to the user, the user will click on that item.

In the following explanation, the two probabilities on the right side of Equation (1) are expressed as the item-user relevance μ(i,u) and the position bias Bk, respectively. That is, it is assumed that μ(i,u)=P(R=1|i,u) and θₖ=P(E=1|k). In NPL 1, the relevance μ(i,u) and the position bias θₖ are estimated using a regression-type EM algorithm. With this regression-type EM algorithm, the probabilities included in the probability model (that is, the relevance μ(i,u) and the position bias θₖ) are estimated by maximum likelihood estimation by alternately repeating an expectation (or “E”) step that calculates an expected value and a maximization (or “M”) step that maximizes the expected value.

Although there are a plurality of positions where an item can be placed on a display screen, items are typically placed in fixed positions based on the experience and expertise of advertisement creators and/or marketers. In other words, as can be understood from Equation (1), out of the plurality of positions that position k could be, the position at which item i is placed will often not include every one out of the plurality of positions. In such cases where there is bias in the actual placement position of an item relative to the plurality of positions where the item could be placed, the conventional position-based click model cannot accurately express the position bias, so that it has not been possible to accurately estimate position bias using a regression-type EM algorithm.

In the present embodiment, a plurality of items are converted into a plurality of embedding vectors, and an improved position-based click model is defined based on this plurality of embedding vectors. After this, the relevance between items and users and the position bias, which are expressed by the improved position-based click model, are estimated using a regression-type EM algorithm.

### Configuration of Information Processing System

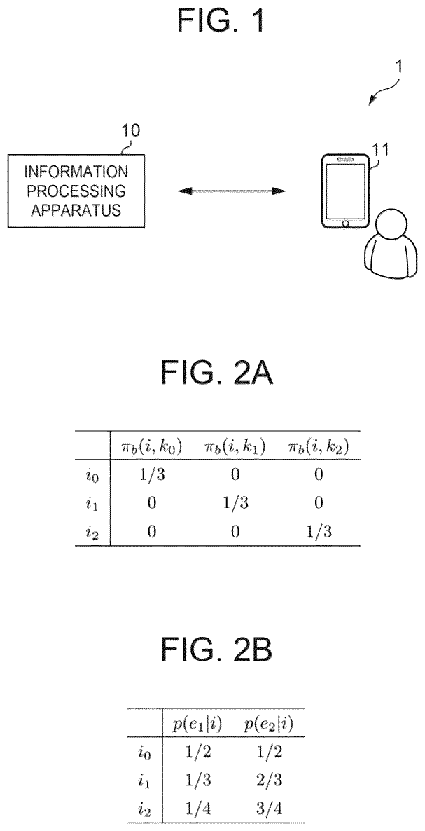

FIG. 1 depicts an example configuration of an information processing system 1 according to the present embodiment. As one example, as depicted in FIG. 1, the information processing system 1 includes an information processing apparatus 10 and a user device 11 that is used by a user. The information processing apparatus 10 and the user device 11 are configured to communicate with each other. Note that in the following description, although one user device 11 is depicted in FIG. 1, a plurality of user devices may be configured to be capable of two-way communication with the information processing apparatus 10. The expression “user device 11” should be understood to refer to any one out of such plurality of user devices.

The user device 11 is a device equipped with a display unit, such as a smartphone, a tablet, or a smart TV. The user device 11 is configured so as to be capable of communicating with the information processing apparatus 10 via a public network, such as 5G (Fifth Generation Mobile Communication System), or a wireless communication network, such as a wireless LAN (Local Area Network). When the user device 11 is a device, such as a smartphone or a tablet, with a GUI (Graphic User Interface) provided on a display unit such as a liquid crystal display, it is possible for the user to perform various operations using the GUI. Such operations include various operations performed on content, like images displayed on the display screen, such as tapping, sliding, and scrolling, using a finger, a stylus, or the like.

Note that the user device 11 is not limited to a device like that depicted in FIG. 1 and may be a device such as a desktop PC (Personal Computer) or a notebook PC. In that case, a user may use an input apparatus such as a mouse or a keyboard to make operations. The user device 11 may also include a separate display unit.

The information processing apparatus 10 may be a server apparatus that provides an electronic commerce platform, such as a marketplace, which makes it possible for the user device 11 to use web services (that is, Internet-related services) provided by the information processing apparatus 10. Note that the information processing apparatus 10 is not limited to being a server apparatus like that mentioned above and the user device 11 may be configured to use a web service provided via the information processing apparatus 10 by a server apparatus (not illustrated) that is separate to the information processing apparatus 10.

The user can click (select) a freely chosen item out of a plurality of items (as examples, advertisements or products) that are provided by a web service and are displayed on the display screen of the user device 11. If the clicked item is a product, following a click operation, a description of the product and information on the procedure for making a purchase may be displayed on the display unit of the user device 11. If the clicked item is an advertisement, a detailed content of the advertisement may be displayed on the display unit of the user device 11.

The information processing apparatus 10 is configured to provide a web service to the user device 11, to observe user behavior on the web service, and to receive a report about such behavior. As one example, the information processing apparatus 10 can acquire observation data which reflects a behavior history of the user on a web service by activating the reception of a report indicating the user behavior history.

In the present embodiment, the information processing apparatus 10 observes the user behavior history, which includes click operations made by the user, on any out of a plurality of items displayed on the display unit of the user device 11. The observation data acquired by the information processing apparatus 10 includes at least one of a user context, information on the positions of items, item information on items, and click information.

A user context includes one or more user attributes (that is, information on the user device 11 or the user himself/herself) that are specific to a user. As examples, the user attributes include the user's name, the user's address, product delivery information, information on a credit card the user has, and user demographic information. Demographic information is information that indicates demography-related user attributes, such as gender, age, region of residence, occupation, and family composition.

User attributes can be registered by a user in order to make use of a web service, for example. In addition to this, or in place of this, the information processing apparatus 10 can acquire user attributes by analyzing web pages that have been viewed by the user, the locations of clicks made in the past, and the like.

The item position information includes information on the positions of items that the user has clicked on the display of the user device 11.

Item information includes information for identifying an item. The item information may also include one or more item features, such as color or size.

The click information is information indicating whether a click has been performed.

The information processing apparatus 10 generates a data set based on such observation data and predetermined configuration information relating to the displaying of items. The configuration information includes information on the plurality of items (including item characteristics) to be displayed on the display screen of the user device and information on every position (a plurality of positions) where the items can be placed. The information processing apparatus 10 converts the plurality of items included in the data set into a plurality of embedding vectors and uses these embedding vectors to define the position bias according to an improved position-based click model. The improved position-based click model referred to here corresponds to a model that is an improvement on the conventional position-based click model in Equation (1) given above. The information processing apparatus 10 then estimates the position bias using a regression-type EM algorithm. The regression-type EM algorithm in the present embodiment corresponds to an improvement on the regression-type EM algorithm disclosed in NPL 1. In the following description, the former is also referred to as the “improved regression-type EM algorithm”, and the latter is also referred to as the “conventional regression-type EM algorithm”.

This improved position-based click model and improved regression-type EM algorithm are described below by tracing the operations performed by the information processing apparatus 10.

### Operation of Information Processing Apparatus

The information processing apparatus 10 acquires observation data n times (where n is a natural number of 2 or higher) for a web service provided to the user device 11 and generates a data set D based on such observation data and predetermined configuration information.

One observation may be an observation made during a certain period. Note that in the present embodiment, it is assumed that the information processing apparatus 10 generates the data set D based on observation data and predetermined configuration information. However, the raw data for generating the data set D is not limited to these, and other data may be used so long as the data set D can be generated by observing the click operations by the user.

The generated data set D is expressed by Equation (2) below.

$$D := {\{ {u}_{j} , {i}_{j} , {c}_{j} , {k}_{j} \}}_{j = 1}^{n} \qquad ( 2 )$$

Here, the index j is an index indicating any one of 1st to nth observations. The user uⱼ is a user with a context (that is, one or more user attributes) that is specific to the user u for the observation j. The user attributes are the user's age and gender, for example.

The item iⱼ is the item i in the observation j, and is associated with a plurality of item features. The item features are features for identifying an item, such as color and size. Although it is assumed that there are n types of items iⱼ in the present embodiment, the present disclosure is not limited to this.

The click cⱼ is a reward variable in the observation j, and in the present embodiment takes the value “1” when the item iⱼ was clicked by the user uⱼ and takes the value “0” when the item iⱼ was not clicked.

The position kⱼ is a position out of a plurality of possible display positions (or “placement positions”) K for the observation j (where kⱼ∈K).

Note that in the following description, when the user uⱼ, the item iⱼ, the click cⱼ, and the position kⱼ are generalized and not limited to the index j, such elements are referred to as “the user u”, “the item i”, “the click c”, and “the position k”, respectively.

A={(i,k)} is the set of actions that includes all possible (i,k) pairs, and π is a function that maps user u onto a distribution of actions, or in other words, a policy (or rule) for placing the item i at the position k. In the present embodiment, the probability (hereinafter also referred to as the “placement probability”) of the item i being placed at (assigned to) the position k (where k∈K) is expressed as “π(i,k)”.

In many cases, this policy is determined by a marketer based on his or her experience and expertise. As a result, the distribution of placement probabilities π(i,k) is usually deterministic and static. In the present embodiment, the data set D is a data set that conforms this type of conventional policy, and it is assumed that there are limited types of (i,k) pairs in the data set D out of all possible (i,k) pairs.

On acquiring the data set D, the information processing apparatus 10 calculates the placement probability π(i,k) for the data set D. The placement probability π(i,k) for the data set D represents the probability (as a ratio) of an item i included in the data set D being placed at each position out of a plurality of positions K where the item can be placed.

As described earlier, in the present embodiment, the data set D includes limited types of pairs (i,k). To quantify the degree of sparseness for such pairs (i,k), the information processing apparatus 10 calculates an index (hereinafter, also referred to as the “placement distribution index”) indicating bias in the distribution of the placement probability π(i,k).

As a first example, if the placement distribution index is expressed as the “sparsity ratio J”, the index can be expressed as indicated in Equation (3). The sparsity ratio represents the ratio of non-missing values (as one example, the expression “missing value” refers to (i,k) values that are missing from the data set D) in the placement distribution.

$$J = \frac{\vert \{ ( i , k ) ∈ D \} \vert}{\vert I \vert \vert K \vert} \qquad ( 3 )$$

Here, “|I| |K|” represents the number of all possible (i,k) pairs (where |I|represents the size of the item set, and |K|represents the size of the position set). “|{(i,k)∈D}|” represents the number of (i,k) pairs (the unique count) in the data set D.

As a second example, the placement distribution index can be expressed as the similarity of the distribution of placement probabilities to a uniform distribution where n items i are uniformly placed at all of the possible positions k. One example of this similarity is the Kullback-Leibler divergence (D_{KL}), which can be expressed as indicated in Equation (4).

$${D}_{KL} ( {π}_{biased} ( i , k ) ‖ {π}_{uniform} ( i , k ) ) = {\sum }_{i} {\sum }_{k} {π}_{biased} ( i , k ) log \frac{{π}_{biased} ( i , k )}{{π}_{uniform} ( i , k )} \qquad ( 4 )$$

Here, “π_{uniform}(i,k)” indicates the placement probability when the item i is uniformly placed at all possible positions k, and π_{biased}(i,k) indicates the placement probability for the data set D.

The sparsity ratio J in Equation (3) indicates the ratio of (i,k) that are actually observed. Accordingly, the lower the sparsity ratio J, the lower the ratio of (i,k) pairs that are actually observed, which indicates that the placements of items are sparse relative to all of the possible placement positions. On the other hand, the larger the Kullback-Leibler divergence D_{KL} indicated in Equation (4), the larger the deviation (dissimilarity) from the uniform distribution, indicating that there is bias in the placement positions of items. By calculating this placement distribution index, the information processing apparatus 10 can grasp the degree of bias in the placement positions of the items in the data set D.

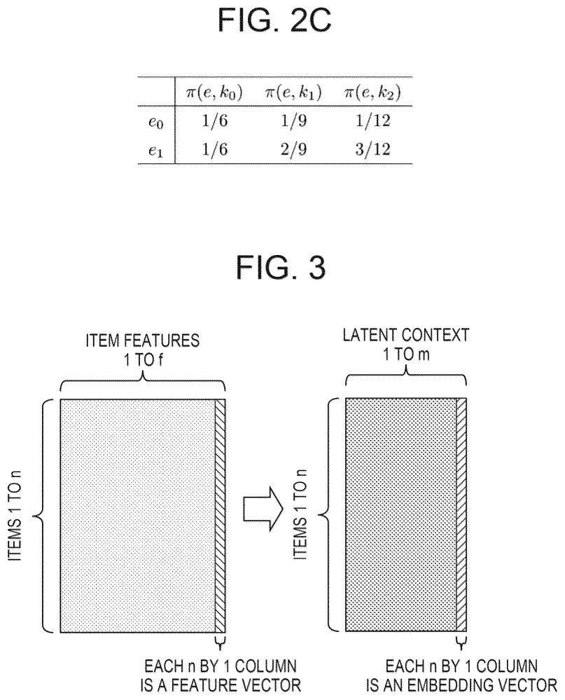

FIG. 2A depicts one example of the distribution of placement probabilities π(i,k) in the data set D. In more detail, FIG. 2A depicts examples of placement probabilities π_{b}(i,k₀), π_{b}(i,k₁), and π_{b}(i,k₂), which indicate the probabilities (ratios) with which items are placed at respective positions, for a case where items i₀, i₁, and i₂ compose a set of every item, and k₀, k₁, and k₂ compose a set of every position at which the items can be placed. Note that in the table in FIG. 2A, π_{biased}(i,k) for the data set D is expressed as the placement probability π_{b}(i,k).

As indicated in the table, in the data set D, item i₀ is placed at position k₀ as a fixed position, item it is placed at position k₁ as a fixed position, and item i₂ is placed at position k₂ as a fixed position. That is, it can be understood that in the data set D, the pairs of items and placement positions are biased toward (i₀,k₀), (i₁,k₁), and (i₂,k₂).

In the case of the distribution of the placemen probability π(i,k) for the data set D depicted in FIG. 2A, in keeping with Equation (3), the sparsity ratio J for the data set D can be calculated as indicated in Equation (5).

$$J = \frac{\vert \{ ( i , k ) ∈ D \} \vert}{\vert I \vert \vert K \vert} = 3 / 9 = 1 / 3 \qquad ( 5 )$$

In keeping with Equation (4), the Kullback-Leibler divergence D_{KL} for the data set D can be calculated as indicated in Equation (6).

$${D}_{KL} ( {π}_{biased} ( i , k ) ‖ {π}_{uniform} ( i , k ) ) = 3 * 1 * log \frac{1 / 3}{1 / 9} = 3 log 3 \qquad ( 6 )$$

As described earlier, for the (i,k) pairs in the data set D, bias occurs for every possible (i,k) pairs. That is, the (i,k) pairs in the data set D are subject to issues of bias and sparseness. When estimating the position bias according to a conventional technique using the data set D and Equation (1), the estimation may not be performed correctly due to the bias and sparseness of the (i,k) pairs included in the data set D.

To address this problem, the information processing apparatus 10 generates a plurality of embedding vectors from the plurality of items in the data set D. In more detail, the information processing apparatus 10 generates m embedding vectors e (where e∈E(E is a set of embedding vectors)) from the n items iⱼ(where j=1 to n) in the data set D. An embedding vector e corresponds to a vector representing latent contexts in which a plurality of item features have been abstracted.

The embedding vectors e will now be described in detail with reference to FIG. 3. FIG. 3 is a diagram useful in explaining the generation of embedding vectors according to the present embodiment.

In the present embodiment, it is assumed that there are n items i and that each item is associated with f item features (where f is a natural number that is equal to or greater than 2). The item features are features for identifying an item, such as color or size. The information processing apparatus 10 first prepares an n by f matrix (items by item features) from the n items i included in the data set D. Each column of the n by f matrix corresponds to a feature vector, and each feature vector represents the item features of one of the n items.

The information processing apparatus 10 converts (maps) the n by f matrix (items by item features) onto an n by m matrix (items by latent context). This conversion can be performed using a known feature extraction technique, such as latent semantic indexing (LSI) or variational auto-encoder (VAE). Each column of the converted n by m matrix corresponds to an embedding vector, and each embedding vector represents the latent context of one of the n items. By doing so, m embedding vectors are generated. These embedding vectors correspond to vectors in which f item features are abstracted and can also be referred to as “abstracted feature vectors”.

By using LSI or VAE to convert an n by f matrix into an n by m matrix, the dimensionality is reduced, that is, m is smaller than f. As one example, LSI can reduce the dimensionality by grouping item features of a plurality of items that have similar meanings. In addition, VAE can reduce dimensionality through compression processing. In this way, due to the size of the n by m matrix becoming smaller in the size than the n by f matrix, sparse (i,k) pairs in the data set D are converted into denser (e,k) pairs.

The probability of assignment from an item i to an embedding vector e (that is, the probability of the embedding vector e that is conditional on the item i) is expressed as an assignment probability “P(e|i)”. FIG. 2B depicts an example distribution of assignment probabilities P(e|i) for the data set D. In more detail, FIG. 2B depicts one example distribution of the assignment probabilities P(e|i) for a case where the items i₀, i₁, and i₂ compose all the items and the number m of embedding vectors is 2. In the present embodiment, for each item i, P(e|i) is calculated so that the sum of the assignment probabilities P(e|i) (that is, the sum of the conditional probabilities of assigning the item i to an embedding vector e) is 1. That is, Σ_{e∈E}(e|i)=1. In FIG. 2B, as one example, the assignment probability P(e₀|i₀) from position i₀ to embedding vector e₀ is ½, and the assignment probability P(e₁|i₀) from position i₀ to embedding vector e₀ is ½, so that P(e₀|i₀)+P(e₁|i₀)=1. For the positions it and i₂, P(e₀|i₁)+P(e₁|i₁)=⅓+⅔=1 and P(e₀|i₂)+P(e₁|i₂)=¼+¾=1, respectively.

The relevance between an item and a user indicated on the right side of Equation (1) can be expressed as in Equation (7) using the assignment probabilities P(e|i) and the embedding vectors e.

$$P ( R = 1 \vert i , u ) = {\sum }_{e ∈ E} P ( e \vert i ) P ( R = 1 \vert e , u ) \qquad ( 7 )$$

From the assignment probabilities P(e|i) and Equation (7), the information processing apparatus 10 can sample the reward w from the clicks C based on the conditional probability in Equation (8) below. Equation (8) represents the probability that the reward w is 1 when the click probability P(C=1|i, u,k) indicated in Equation (1) is multiplied by the assignment probability P(e|i).

$$P ( w = 1 \vert e , u , k ) = P ( e \vert i ) P ( C = 1 \vert i , u , k ) \qquad ( 8 )$$

As described above, by generating the embedding vector e and sampling the reward w, the information processing apparatus 10 generates, from the data set D, a data set Dₑ which as depicted in Equation (9) below includes the embedding vector e and the reward w.

$${D}_{e} := {\{ {u}_{j} , {e}_{j} , {w}_{j} , {k}_{j} \}}_{j = 1}^{n \vert E \vert} \qquad ( 9 )$$

Using the embedding vectors e, the conventional position-based click model depicted in Equation (1) can be expressed as indicated in Equation (10) as an improved position-based click model that includes embedding vectors.

$$P ( w = 1 \vert e , u , k ) = P ( R = 1 \vert e , u ) P ( E = 1 \vert k ) \qquad ( 10 )$$

In the following description, the two probabilities on the right side of Equation (10) express the relevance μ(e, u) between embedding vectors and users, and the position bias θₑₖ, respectively. That is, it is assumed that μ(e, u)=P(R=1|e, u) and θₑₖ=P(E=i|k). To distinguish from the positional bias θₖ in Equation (1), the position bias θₑₖ in Equation (10) represents the probability that the user u examines each of the k positions where the m embedding vectors are placed.

As described earlier, in the present embodiment, for each item i, the assignment probability P(e|i) is calculated so that the sum of P(e|i) is 1, and P(e|i) is defined as indicated in Equation (11) below.

$$P ( e \vert i ) = {\prod }_{l = 1}^{m} \frac{exp ( {e}_{i , l} )}{{\sum }_{l ′ = 1}^{m} exp ( {e}_{i , l ′} )} \qquad ( 11 )$$

Here, e_{i,l} (EE) refers to each element in a matrix of embedding vectors (items by latent contexts depicted in FIG. 3). “e_{i,l}” corresponds to a representation (or “embedding space representation”) in an embedding space. Also, l and l′ in Equation (11) represent the latent context, with l′ and l as independent parameters.

If two items i and i′ are similar, it is assumed that their corresponding embedding space representations e_{i,l} and e_{i′,l}, will also be similar and the distributions of the assignment probabilities P(e|i) and P(e|i′) will also be similar.

Based on this assumption, when observing pairs with a specified (item, position), such as (i₀, k₀) and (i₁, k₁), in the data set D, it is possible to obtain the assignment probabilities P(e₀|i₀), P(e₁|i₀), P(e₀|i₁), and P(e₁|i₁). Since it is possible, by using the data set Dₑ, to use both positions for the embedding vectors e₀ and eₗ (that is, (e₀,k₀) and (e₀,k₁) for the case of the embedding vector e₀), the problems of bias and sparseness described above can be resolved.

The information processing apparatus 10 derives a placement probability π(e,k) that represents a probabilistic expression of an embedding vector e being placed at each position k in the data set D, using the distribution of the placement probability π(i,k) and the distribution of the assignment probability P(e|i). In the present embodiment, the assignment probability π(e,k) is derived (calculated) using a sum of products of the assignment probability P(e|i) and the placement probability π(i,k).

FIG. 2C depicts an example of the placement probabilities π(e,k) for the assignment probabilities P(e|i) depicted in FIG. 2B. The placement probability π(e,k) indicates the placement probability π(e,k) for the data set Dₑ based on the assignment probability P(e|i) depicted in FIG. 2B and the placement probability π_{b}(i,k) for the data set D depicted in FIG. 2A.

The placement probability π(eₚ,k_{q}) can be calculated as the sum of products of the assignment probability P(eₚ|i) and the placement probability π_{b}(i, k_{q}) for all items i in the data set Dₑ.

As one example, in FIG. 2C, the placement probability π(e₀, k₀) can be calculated as indicated in Equation (12) below.

$$π ( {e}_{0} , {k}_{0} ) = {\sum }_{j} P ( {e}_{0} , \vert {i}_{j} ) π ( {i}_{j} , {k}_{0} ) = 1 / 2 * 1 / 3 + 1 / 3 * 0 + 1 / 4 * 0 = 1 / 6 \qquad ( 12 )$$

Here, j is the index of an item in the data set Dₑ.

As depicted in FIG. 2C, the issues of data bias and sparseness are resolved for the placement probability π(e,k) compared to the placement probability π_{b}(i,k) depicted in FIG. 2A. For this reason, it is expected that position bias will be estimated more accurately using the data set Dₑ including the embedding vectors e and the positions k.

Next, the information processing apparatus 10 estimates the position bias using the data set Dₑ. In the past, the position bias indicated by the conventional position-based click model given in Equation (1) was estimated using the regression-type EM algorithm described in NPL 1. That is, the relevance μ(i, u) and the position bias θₖ are optimized by repeating an expectation step and a maximization step using a regression-type RM algorithm.

In the present embodiment, as the improved regression-type RM algorithm, first, in the expectation step, in the t+1 iteration relative to a certain time t, the distributions of the hidden variables E and R are estimated from θₑₖ^{(t)} and μ^{(t)}(e, u). As described above with reference to Equation (10), θₑₖ^{(t)} and μ^{(t)}(e, u) are the position bias θₑₖ and the relevance μ(e, u) between the embedding vector and the user at time t, respectively.

$$P ( E = 1 , R = 1 \vert w = 1 , e , k ) = 1 \\ P ( E = 1 , R = 0 \vert w = 0 , e , k ) = \frac{{θ}_{ek}^{( t )} ( 1 - {μ}^{( t )} ( e , u ) )}{1 - {θ}_{ek}^{( t )} {μ}^{( t )} ( e , u )} \\ P ( E = 0 , R = 1 \vert w = 0 , e , k ) = \frac{( 1 - {θ}_{ek}^{( t )} ) {μ}^{( t )} ( e , u )}{1 - {θ}_{ek}^{( t )} {μ}^{( t )} ( e , u )} \\ P ( E = 0 , R = 0 \vert w = 0 , e , k ) = \frac{( 1 - {θ}_{ek}^{( t )} ) ( 1 - {μ}^{( t )} ( e , u ) )}{1 - {θ}_{ek}^{( t )} {μ}^{( t )} ( e , u )} \qquad ( 13 )$$

From Equation (13), the probability P(E=1|u, e, w, k) and the probability P(R=1|u, e, w, k) can be calculated for every data point in the data set Dₑ. The probability P(E=1|u, e, w, k) represents the probability of relevance existing (=1) between the user u and the embedding vector e when the user u, the embedding vector e, the reward w, and the position k are given as conditions. The probability P(E=1|u, e, w, k) represents the probability that the position k is examined by the user u, when the user u, the embedding vector e, the reward w, and the position k are given as conditions.

In the maximization step, the probabilities from the expectation step are used to calculate θₑₖ^{(t+1)} and μ^{(t+1)}(e,k).

$${θ}_{ek}^{( t + 1 )} = \frac{{\sum }_{( u , e , w , k ′ ) ∈ {D}_{e}} {I}_{k ′ = k} ( w + ( 1 - w ) P ( E = 1 \vert u , e , w , k ) )}{{\sum }_{( u , e , w , k ′ ) ∈ {D}_{e}} {I}_{k ′ = k}} \\ {μ}^{( t + 1 )} ( e , u ) = \frac{{\sum }_{( u , e ′ , w , k ) ∈ {D}_{e}} {I}_{e ′ = e} ( w + ( 1 - w ) P ( R = 1 \vert u , e , w , k ) )}{{\sum }_{( u , e ′ , w , k ) ∈ {D}_{e}} {I}_{e ′ = e}} \qquad ( 14 )$$

Here, although k′ and e′ represent the position k and the embedding vector e, respectively, the position k and embedding vector e are independent parameters. Also in Equation (14), the denominator I represents the indicator function. That is, I_{k′=k} is a function that takes the value 1 when k′=k but otherwise takes the value 0. In the same way, I_{e′=e} is a function that takes the value 1 when e′=e but otherwise takes the value 0.

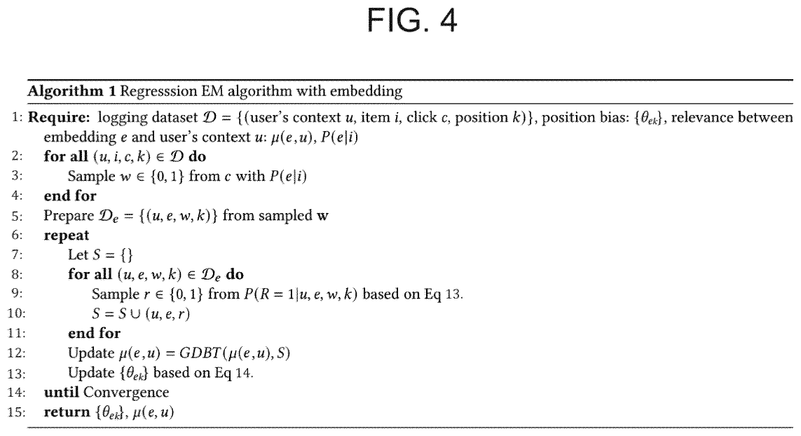

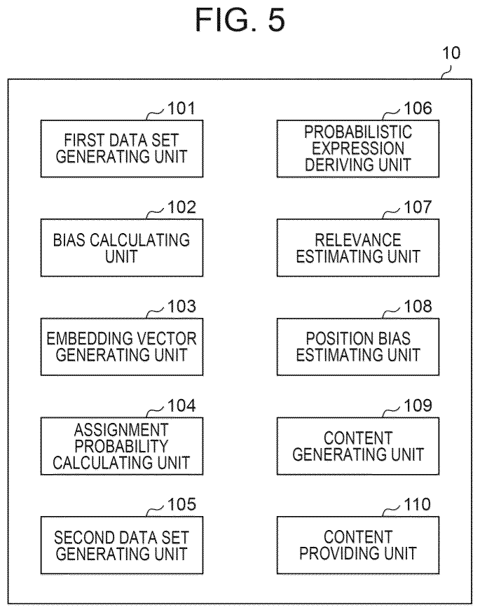

Based on Equations (13) and (14), the improved regression-type EM algorithm according to the present embodiment is depicted in FIG. 4. The processes in this algorithm are described in order below.

### Process 1

A data set D including the user (user context) u, the item i, the click c, and the position k, a position bias θₑₖ, a relevance μ(e,u) between embedding vectors and users, and an assignment probability P(e|i) is received as an input. Here, θₑₖ may have a predetermined initial value. μ(e,u) may be an empty regression model.

### Processes 2 to 4

For every user u, item i, click c, and position k included in the data set D, the reward w is sampled from the click c with the assignment probability P(e|i). In more detail, the reward w where w∈{0, 1}, that is, takes the value 0 or 1, is sampled according to Equation (8).

### Process 5

The data set Dₑ including the user (user context) u, the item i, the reward w, and the position k is prepared (generated) from the data set D and the reward w sampled in Process 4.

### Processes 6 to 14

The processes 7 to 13 are repeated (that is, repeated from time t to time t+1) until the condition in Process 14 is satisfied.

### Process 7

Let set S be an empty set.

### Processes 8 to 11

For every user u, embedding vector e, click c, and position k included in the data set Dₑ, the relevance r, where r E {0, 1}, that is, takes the value 0 or 1, is sampled from the probability P(R=1| u, e, w, k) based on Equation (13). Next, a union set S of the users u, the embedding vectors e, the relevance r, and the set S is generated.

### Process 12

μ(e,u) is updated according to GBDT (Gradient Boosted Decision Tree) with μ(e,u) and S as inputs. GBDT is used here to learn μ(e,u) since the relevance between items and users can be nonlinear.

### Process 13

θₑₖ is updated according to Equation (14).

### Process 14

If the difference between the updated θₑₖ values at time t and time t+1 is equal to or less than a predetermined value, it is determined that the convergence condition is satisfied and the processing ends. As one example, the predetermined value is 10⁻³. Here, in addition to the values of θₑₖ updated at time t and time t+1, if the difference in μ(e,u) updated at time t and time t+1 is equal to or less than a predetermined value, it is possible to determine that the convergence condition is satisfied and end the processing.

### Process 15

θₖ and μ(e,u) are returned.

In this way, in the present embodiment, even for a data set D in which the types of pairs (i, k) indicating the placement positions of items are limited, the items i are converted to embedding vectors e and a data set Dₑ including (e, k) pairs is generated. The position bias θₑₖ is then estimated according to the improved regression-type EM algorithm depicted in FIG. 4. By doing so, it is possible to estimate the position bias θₑₖ with higher accuracy than when estimating the position bias θₖ according to the conventional regression-type EM algorithm.

When the information processing apparatus 10 estimates the position bias θₑₖ according to the improved regression-type EM algorithm depicted in FIG. 4, the information processing apparatus 10 may adjust the placement positions of items for each user based on this estimated position bias θₑₖ. In more detail, first, the information processing apparatus 10 estimates the relevance μ(i, u)=P(R=1|i, u) between items and users in the position-based click model indicated in Equation (1) using the conventional regression-type EM algorithm, and identifies one or more items that are highly relevant to the user u. In addition to or in place of this, the information processing apparatus 10 may specify one or more items in order of relevance to the user u.

Next, the information processing apparatus 10 estimates the position bias θₑₖ=P(E=1|k) in the improved position-based click model indicated in Equation (10) using the improved regression-type EM algorithm depicted in FIG. 4. After this, the information processing apparatus 10 identifies a position or positions that is/are likely to be examined by the user u based on the estimated position bias θₑₖ, and places (matches) the identified one or more items to the identified position(s). By doing so, the probability of the user u clicking on the one or more items is increased, that is, it is possible to increase the click-through rate (CTR), which increases the effectiveness of advertising.

### Functional Configuration of Information Processing Apparatus

FIG. 5 depicts an example configuration of the information processing apparatus 10 according to the present embodiment. The information processing apparatus 10 has a first data set generating unit 101, a bias calculating unit 102, an embedding vector generating unit 103, an assignment probability calculating unit 104, a second data set generating unit 105, a probabilistic expression deriving unit 106, a relevance estimating unit 107, a position bias estimating unit 108, a content generating unit 109, and a content providing unit 110.

The first data set generating unit 101 generates a data set D that reflects the behavior history of a user on a web service. As one example, the first data set generating unit 101 generates the data set D based on observation data of a behavior history of the user on a web service and predetermined configuration information relating to the displaying of items. As described earlier, the data set D is configured to include the user u, the item i, the click c, and the position k for each observation numbered 1 to n. The item i is associated with f item features.

The first data set generating unit 101 calculates and acquires the placement probability π(i, k) for the data set D. One example distribution of the placement probability π(i, k) for the data set D is depicted in FIG. 2A.

The bias calculating unit 102 calculates the placement distribution index which indicates an index indicating bias in the distribution of the placement probability π(i, k) calculated by the first data set generating unit 101. As described earlier, in the present embodiment, the sparsity ratio J defined by Equation (3) and the Kullback-Leibler divergence D_{KL} defined by Equation (4) are calculated. The smaller the value of the sparsity ratio J, the stronger the bias in the placement positions of items. On the other hand, the larger the Kullback-Leibler divergence D_{KL}, the stronger the bias in the placement positions of items.

The embedding vector generating unit 103 converts the n items i included in the data set D into m embedding vectors e that represent abstract expressions of item features of the n items i. In the present embodiment, as described above with reference to FIG. 3, the embedding vector generating unit 103 prepares an n by f matrix (items by item features) from the n items i included in the data set D. The embedding vector generating unit 103 then converts (maps) the matrix onto an n by m (items by latent context) matrix. The embedding vector generating unit 103 generates each column of the converted n by m matrix as an embedding vector e.

The assignment probability calculating unit 104 calculates an assignment probability P(e|i) that represents the probability of assignment from the n items i included in the data set D to the m embedding vectors e (that is, the probability of embedding vector e given item i as a condition). FIG. 2B depicts an example distribution of the assignment probabilities P(e|i) for the data set D. The assignment probability calculating unit 104 can calculate the assignment probabilities P(e|i) for each item i so that the sum of the assignment probabilities P(e|i) is 1.

The second data set generating unit 105 generates the data set Dₑ. In more detail, as described earlier, the second data set generating unit 105 samples, in keeping with Equation (8), the reward w, which takes the value 0 or 1, from a click c with an assignment probability P(e|i) calculated by the assignment probability calculating unit 104. After this, the second data set generating unit 105 generates, from the set of rewards w and the data set D, the data set Dₑ including the user u, the item i, the reward w, and the position k.

The probabilistic expression deriving unit 106 derives, for each position k in the data set D, the placement probability π(e, k), which represents a probabilistic expression of the embedding vector e being placed, using the distribution of the placement probability π(i, k) and the distribution of the assignment probability P(e|i). The probabilistic expression deriving unit 106 can derive (calculate) the placement probability π(e, k) using a sum of products of the assignment probability P(e|i) and the placement probability π(i, k). An example distribution of the probabilistic expression is depicted in FIG. 2C.

The relevance estimating unit 107 estimates the relevance μ(i, u) between an item i and a user u in the data set D. In more detail, the relevance estimating unit 107 estimates the relevance μ(i, u) indicated in Equation (1) using the conventional regression-type EM algorithm.

The position bias estimating unit 108 estimates the position bias θₑₖ for the data set Dₑ. In more detail, the position bias estimating unit 108 estimates the position bias θₑₖ indicated in Equation (10) using the improved regression-type EM algorithm depicted in FIG. 4. Alternatively, or in addition to this, the position bias estimating unit 108 may estimate the position bias θₖ for the data set D. In more detail, the position bias estimating unit 108 estimates the position bias θₖ indicated in Equation (1) using the conventional regression-type EM algorithm.

The position bias estimating unit 108 may switch between estimating the position bias using the conventional regression-type EM algorithm and the improved regression-type EM algorithm based on the placement distribution index calculated by the bias calculating unit 102.

As one example, in a case where the sparsity ratio J is used as the placement distribution index, when the sparsity ratio J is equal to or lower than a predetermined value (that is, when the number of missing values in the placement distribution is equal to or higher than a predetermined level), the position bias estimating unit 108 can estimate the position bias θₑₖ indicated in Equation (10) using the improved regression-type EM algorithm depicted in FIG. 4. On the other hand, when the sparsity ratio J is greater than the predetermined value (that is, the number of missing values in the placement distribution is less than the predetermined level), the position bias estimating unit 108 can estimate the position bias Ok indicated in Equation (1) using the conventional regression-type EM algorithm.

As another example, in the case where Kullback-Leibler divergence D_{KL} is used as the placement distribution index, when the divergence D_{KL} is equal to or greater than a predetermined value (that is, when the bias in the placement distribution is equal to or greater than a predetermined level), the position bias estimating unit 108 can estimate the position bias θₑₖ indicated in Equation (10) using the improved regression-type EM algorithm depicted in FIG. 4. On the other hand, when the divergence D_{KL} is smaller than the predetermined value (that is, the bias in the placement distribution is less than the predetermined level), the position bias estimating unit 108 can estimate the position bias θₖ indicated in Equation (1) using the conventional regression-type EM algorithm.

In this way, when there is no bias in the placement positions of items, it is possible to suppress the processing load by estimating the position bias θₖ from the data set D using the conventional method, without generating the data set Dₑ.

The content generating unit 109 generates content to be provided to the user u based on the relevance μ(i, u) between the item i in the data set D and the user u estimated by the relevance estimating unit 107 and the position bias θₖ or the position bias θₑₖ estimated by the position bias estimating unit 108. When the content is advertising content including a plurality of advertisements (that is, “items”), the content generating unit 109 ranks the plurality of advertisements in order of relevance to the user u based on the relevance μ(i, u). The content generating unit 109 then assigns the ranked advertisements to the respective positions based on the position bias θₖ or the position bias θₑₖ to generate advertising content.

The content providing unit 110 provides the user u with the content generated by the content generating unit 109. As one example, the content providing unit 110 has the generated content displayed on a display unit of a user device used by the user u.

In this way, with the information processing apparatus 10 according to the present embodiment, first, the first data set generating unit 101 acquires the placement probabilities π(i, k), which represent the probability that each of a plurality of items will be placed at a plurality of positions, for the data set D. After this, the embedding vector generating unit 103 converts the plurality of items into a plurality of embedding vectors. Next, the assignment probability calculating unit 104 calculates the assignment probability P(e|i) representing the probability of assignment from the plurality of items to the plurality of embedding vectors. After this, the probabilistic expression deriving unit 106 derives, for each of the plurality of positions, a placement probability π(e, k) indicating a probabilistic expression of each of the plurality of embedding vectors being placed, using the distribution of the placement probability and the distribution of the assignment probability. The position bias estimating unit 108 estimates the position bias θₑₖ indicated in Equation (10) using the improved regression-type EM algorithm depicted in FIG. 4.

In addition, with the information processing apparatus 10, the content generating unit 109 can generate content so as to place items that are highly relevant to the user at positions that the user is likely to examine so that the content providing unit 110 can provide the generated content to the user.

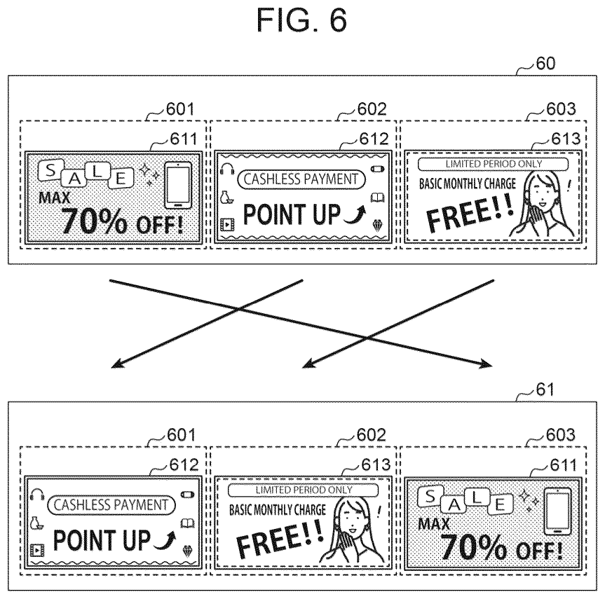

One example of content in which a plurality of items have been placed at a plurality of positions is depicted in FIG. 6. In FIG. 6, the upper part depicts advertising content 60 in which the advertisement items 611, 612, and 613 have been placed in a fixed arrangement at positions 601, 602, and 603, respectively. Here, it is assumed that out of the values of relevance between the user u and the respective advertisement items estimated by the relevance estimating unit 107, the relevance between the user u and the advertisement item 612 is the highest, followed by the relevance between the user u and the advertisement items 613 and 611 in that order. It is also assumed that out of the position bias θₖ (or the position bias Ok) for each position estimated by the position bias estimating unit 108, the position bias for the position 601 is the highest, followed by the position biases for the positions 602 and 603. In this case, the content generating unit 109 generates advertising content 61 in which the advertisement items 612, 613, and 611 have been assigned to the positions 601, 602, and 603, respectively, as depicted in the lower part of FIG. 6. The content providing unit 110 then provides the created advertising content 61 to the user u. As one example, the content providing unit 110 performs control so that the advertising content 61 is displayed on the display unit of the user device 11 of the user u.

In the advertising content 61 on the display unit of the user device 11 of the user u, the advertisement item 612 that is of high interest to the user u is placed at the position 601 that has high position bias. By doing so, it is possible not only to produce a more personalized display for the user u, but to also increase the probability that the user u will click the advertisement item 612, which can improve the CVR (conversion rate) and achieve effective marketing.

### Hardware Configuration of Information Processing Apparatus 10

Next, one example of the hardware configuration of the information processing apparatus 10 will be described. The user device 11 may also have the same hardware configuration.

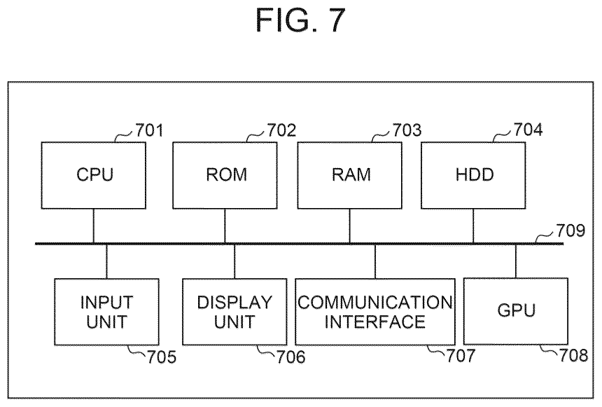

FIG. 7 is a block diagram depicting one example of the hardware configuration of the information processing apparatus 10 according to the present embodiment.

The information processing apparatus 10 according to the present embodiment can be implemented on one or a plurality of computers, mobile devices, or any other processing platform.

Although one example where the information processing apparatus 10 is implemented on a single computer is depicted in FIG. 7, the information processing apparatus 10 according to the present embodiment may be implemented on a computer system including a plurality of computers. The plurality of computers may be connected to each other via a wired or wireless network to enable the computers to communicate with each other.

As depicted in FIG. 7, the information processing apparatus 10 may include a CPU (Central Processing Unit) 701, a ROM (Read Only Memory) 702, a RAM (Random Access Memory) 703, an HDD (Hard Disk Drive) 704, an input unit 705, a display unit 706, a communication interface 707, a GPU (Graphics Processing Unit) 708, and a system bus 709. The information processing apparatus 10 may also include an external memory.

The CPU 701 performs overall control of the operations of the information processing apparatus 10, and controls the respective components (702 to 708) via the system bus 709, which is a data transfer path.

The ROM 702 is a non-volatile memory that stores a control program and the like that are necessary for the CPU 701 to execute processing. Note that such program may be stored in a non-volatile memory such as the HDD 704 or an SSD (Solid State Drive) or an external memory such as a removable storage medium (not illustrated).

The RAM 703 is a volatile memory and functions as a main memory, a work area, and the like of the CPU 701. That is, when executing processing, the CPU 701 loads the necessary program and the like from the ROM 702 into the RAM 703 and executes the program and the like to realize various functional operations.

As one example, the HDD 704 stores various data, various information, and the like that are required when the CPU 701 performs processing using a program. The HDD 704 may also store various data, various information, and the like obtained when the CPU 701 performs processing using a program or the like.

The input unit 705 is composed of a keyboard and/or a pointing device such as a mouse.

The display unit 706 is composed of a monitor, such as a liquid crystal display (LCD). The display unit 706 may be configured to function in combination with the input unit 705 as a GUI (Graphical User Interface).

The communication interface 707 is an interface that controls communication between the information processing apparatus 10 and an external apparatus.

The communication interface 707 provides an interface with a network and executes communication with an external apparatus via the network. Various data and various parameters are transferred to and from the external apparatus via this communication interface 707. In the present embodiment, the communication interface 707 may execute communication via a wired LAN (Local Area Network) or dedicated line that complies with a communication standard, such as Ethernet (registered trademark). However, the network that can be used in the present embodiment is not limited to these examples, and may be configured as a wireless network. Wireless networks include wireless personal area networks (PANs) such as Bluetooth (registered trademark), ZigBee (registered trademark), and UWB (Ultra Wide Band). The expression “wireless networks” also includes wireless LANs (Local Area Networks), such as Wi-Fi (Wireless Fidelity) (registered trademark), and wireless MANs (Metropolitan Area Networks), such as WiMAX (registered trademark). “Wireless networks” also includes wireless WANs (Wide Area Networks), such as 4G and 5G. Note that it is sufficient for the network to connect devices to each other to enable communication, and the communication standard, scale, and configuration are not limited to the examples given above.

The GPU 708 is a processor dedicated to image processing. The GPU 708 can cooperate with the CPU 701 to perform predetermined processing.

At least some functions of the respective elements of the information processing apparatus 10 depicted in FIG. 5 can be realized by the CPU 701 executing a program. However, at least some of the functions of each element of the information processing apparatus 10 depicted in FIG. 5 may also operate as dedicated hardware. In this case, the dedicated hardware operates based on control by the CPU 701.

### User Attributes

As mentioned above, in the present embodiment, the user context includes one or more user attributes that are associated with the user. Some examples of user attributes are given below.

The user attributes include factual characteristics (factual information) about an apparatus (or “user device”) owned by the user or about the user himself/herself. The factual characteristics referred to here may be fact-based features (information) that are actually or objectively obtained from a user device or from the user himself/herself.

The user attributes may also include user attributes (or “estimated user attributes”) that have been estimated by applying a trained machine learning model to fact-based features. As one example, the machine learning model is configured to input fact-based features on a target user and output the probability (or “applicability probability”) that each of a plurality of user attributes applies to (that is, matches) the target user. Estimated user attributes can be determined from this applicability probability.

### Item Features

As described earlier, in the present embodiment, an item is associated with a plurality of item features. Some examples of item features are given below.

The item features of an item may include information identifying the item (item ID), information identifying the genre (a higher-order classification) of the item, and information identifying a shop where the item is sold (shop ID). The item features can also include transaction information (such as a number of transactions) for an item ID and genre ID and/or for an item ID and a shop ID, in keeping with a transaction history.

Note that although a specific embodiment has been described above, the embodiment is a mere example and is not intended to limit the scope of the invention. The apparatus and method described in this specification may be implemented in forms aside from the embodiment described above. It is also possible to appropriately make omissions, substitutions, and modifications to the embodiment described above without departing from the scope of the invention. Implementations with such omissions, substitutions, and modifications are included in the scope of the patent claims and their equivalents, and belong to the technical scope of the present invention.

The disclosure includes the following embodiments.

[1] An information processing apparatus comprising: an acquisition unit that acquires a placement probability that expresses a probability of each of n items, where n is a natural number of 2 or higher, being placed at k positions, where k is a natural number of 2 or higher; a conversion unit that converts the n items into m embedding vectors, where m is a natural number of 2 or higher, that express abstract representations of features of the n items; a calculation unit that calculates an assignment probability that expresses a probability of assignment from the n items to the m embedding vectors; and a deriving unit that derives, using a distribution of the placement probability and a distribution of the assignment probability, a probability expression of each of the m embedding vectors being placed at each of the k positions.

[2] The information processing apparatus according to [1], wherein in the assignment probability, for each of the n items, a sum of conditional probabilities of the item being assigned to the embedding vectors is 1.

[3] The information processing apparatus according to [1], wherein each of the n items is associated with f features, where f is a natural number that is 2 or higher, and the conversion unit converts the n items associated with the f features into the m embedding vectors, where m is less than f.

[4] The information processing apparatus according to any one of [1] to [3], further comprising an estimation unit that estimates, based on the placement probability, position bias expressing a probability that a user examines each of the k positions at which the m embedding vectors have been placed.

[5] The information processing apparatus according to any one of [1] to [4], further comprising: a first estimation unit that estimates, based on the assignment probability, a first position bias expressing a probability that a user examines each of the k positions at which the m embedding vectors have been placed; and a second estimation unit that estimates, based on the placement probability, a second position bias expressing a probability that a user examines each of the k positions at which the n items have been placed.

[6] The information processing apparatus according to [5], further comprising a bias calculation unit that calculates bias in a distribution of the placement probability, wherein in a case where the bias in the distribution of the placement probability is greater than or equal to a predetermined level, the first estimation unit estimates the first position bias, and in a case where the bias in the distribution of the placement probability is less than the predetermined level, the second estimation unit estimates the second position bias.

[7] The information processing apparatus according to [6], wherein the bias calculation unit calculates a ratio of the n items being placed out of the k positions in the distribution of the placement probability as the bias in the distribution of the placement probability.

[8] The information processing apparatus according to [6], the bias calculation unit calculates a similarity between the distribution of the placement probability and a uniform distribution of the n items at the k positions as the bias in the distribution of the placement probability.

[9] The information processing apparatus according to [8], wherein the bias calculation unit calculates the similarity using Kullback-Leibler divergence.

### REFERENCE SIGNS LIST

1: Information processing system
10: Information processing apparatus
11: User apparatus
101: First data set generating unit
102: Bias calculating unit
103: Embedding vector generating unit
104: Assignment probability calculating unit
105: Second data set generating unit
106: Probabilistic expression deriving unit
107: Relevance estimating unit
108: Position bias estimating unit
109: Content generating unit
110: Content providing unit

What is claimed is:

1. An information processing apparatus comprising:
an acquisition unit that acquires a placement probability that expresses a probability of each of n items, where n is a natural number of 2 or higher, being placed at k positions, where k is a natural number of 2 or higher;
a conversion unit that converts the n items into m embedding vectors, where m is a natural number of 2 or higher, that express abstract representations of features of the n items;
a calculation unit that calculates an assignment probability that expresses a probability of assignment from the n items to the m embedding vectors; and
a deriving unit that derives, using a distribution of the placement probability and a distribution of the assignment probability, a probability expression of each of the m embedding vectors being placed at each of the k positions.

2. The information processing apparatus according to claim 1,
wherein in the assignment probability, for each of the n items, a sum of conditional probabilities of the item being assigned to the embedding vectors is 1.

3. The information processing apparatus according to claim 1,
wherein each of the n items is associated with f features, where f is a natural number that is 2 or higher, and
the conversion unit converts the n items associated with the f features into the m embedding vectors, where m is less than f.

4. The information processing apparatus according to claim 1, further comprising
an estimation unit that estimates, based on the placement probability, position bias expressing a probability that a user examines each of the k positions at which the m embedding vectors have been placed.

5. The information processing apparatus according to claim 1, further comprising:
a first estimation unit that estimates, based on the assignment probability, a first position bias expressing a probability that a user examines each of the k positions at which the m embedding vectors have been placed; and
a second estimation unit that estimates, based on the placement probability, a second position bias expressing a probability that a user examines each of the k positions at which the n items have been placed.

6. The information processing apparatus according to claim 5, further comprising
a bias calculation unit that calculates bias in a distribution of the placement probability,
wherein in a case where the bias in the distribution of the placement probability is greater than or equal to a predetermined level, the first estimation unit estimates the first position bias, and
in a case where the bias in the distribution of the placement probability is less than the predetermined level, the second estimation unit estimates the second position bias.

7. The information processing apparatus according to claim 6,
wherein the bias calculation unit calculates a ratio of the n items being placed out of the k positions in the distribution of the placement probability as the bias in the distribution of the placement probability.

8. The information processing apparatus according to claim 6,
the bias calculation unit calculates a similarity between the distribution of the placement probability and a uniform distribution of the n items at the k positions as the bias in the distribution of the placement probability.

9. The information processing apparatus according to claim 8,
wherein the bias calculation unit calculates the similarity using Kullback-Leibler divergence.

10. An information processing method comprising:
acquiring a placement probability that expresses a probability of each of n items, where n is a natural number of 2 or higher, being placed at k positions, where k is a natural number of 2 or higher;
converting the n items into m embedding vectors, where m is a natural number of 2 or higher that express abstract representations of features of the n items;
calculating an assignment probability that expresses a probability of assignment from the n items to the m embedding vectors; and
deriving, using a distribution of the placement probability and a distribution of the assignment probability, a probability expression of each of the m embedding vectors being placed at each of the k positions.

11. A non-transitory computer readable medium storing a computer program for causing a computer to execute an information processing method, the information processing method comprising:
acquiring a placement probability that expresses a probability of each of n items, where n is a natural number of 2 or higher, being placed at k positions, where k is a natural number of 2 or higher;
converting the n items into m embedding vectors, where m is a natural number of 2 or higher, that express abstract representations of features of the n items;
calculating an assignment probability that expresses a probability of assignment from the n items to the m embedding vectors; and
deriving, using a distribution of the placement probability and a distribution of the assignment probability, a probability expression of each of the m embedding vectors being placed at each of the k positions.
